(19) United States
(12) Patent Application Publication
(10) Pub. No.: US 2005/0121055 A1
(43) Pub. Date: Jun. 9, 2005

(54) Cleaning method

(76) Inventor: Karlheinz Straub, Heidenheim (DE)

Correspondence Address: Todd T. Taylor;Taylor & Aust, P.C., 142 South Main St., P.O. Box 560, Avilla, IN, 46710, US

(21) Appl. No.: 11/035,094

(22) Filed: Jan. 13, 2005

Related U.S. Application Data
(63) Continuation of application No. PCT/EP03/05031, filed on Jul. 18, 2003.

(30) Foreign Application Priority Data
Jul. 25, 2002 (DE) 102 33 796.9

(51) Int. Cl. B08B 7/00

(52) U.S. Cl. 134/9; 134/198; 134/34

(57) ABSTRACT

A method for controlling a cleaning of an endlessly circulating belt in a machine for at least one of producing a fiber web and finishing the fiber web, includes the steps of: providing a cleaning device and a traversing unit coupled thereto; applying a cleaning liquid to the belt with the cleaning device; moving the cleaning device transversely with respect to the belt running direction with the traversing unit; and controlling a traversing speed as a function of a traversing direction. Another method for controlling a cleaning of the belt includes the steps of: providing a cleaning device and a traversing unit coupled thereto; applying a cleaning liquid to the belt with the cleaning device; moving the cleaning device transversely with respect to the belt running direction with the traversing unit; and controlling a quantity of the cleaning liquid applied to the belt as a function of a traversing direction.

### CROSS REFERENCE TO RELATED APPLICATIONS

This is a continuation of PCT application No. PCT/EP2003/050321, entitled “CLEANING METHOD”, filed Jul. 18, 2003.

### BACKGROUND OF THE INVENTION

1. Field of the invention

The present invention relates to a method for controlling the cleaning of an endlessly circulating belt in a machine for producing and/or finishing a paper, board, tissue or other fibrous web, having a cleaning device which applies cleaning liquid to the belt and a traversing unit coupled thereto which moves the cleaning device transversely with respect to the belt running direction.

2. Description of the related art

Cleaning devices have been known for a long time in a number of embodiments. The disadvantage of previously known cleaning devices is that the edge regions have a relatively large amount of cleaning liquid applied to them during the reversal of the traversing movement. This can in turn have a detrimental effect on the transverse moisture profile of the fibrous web coming into contact with the belt after the cleaning. In addition, in particular the regions lying off-center are cleaned at time intervals of different lengths during the traversing movement, which can lead to excessively high contamination after a long interval.

What is needed in the art is to improve the cleaning action with the optimized use of cleaning liquid.

### SUMMARY OF THE INVENTION

The present invention provides that the traversing speed is controlled as a function of the traversing direction. Since the outer regions of the belt are only cleaned again after a relatively long time interval in each case, after a short one in the case of a uniform traversing movement, by changing the traversing speed there is the possibility of influencing the quantity of cleaning liquid applied to the relevant area of the belt to be cleaned. This can be done in particular by the traversing speed, at least viewed over the entire traversing distance, being lower in one traversing direction, the working stroke, than in the opposite traversing direction, the return stroke.

The result of this is that the cleaning can be carried out substantially during the working stroke and thus at regular time intervals. In addition, the edges of the belt are not so highly loaded with liquid during the traversing reversal. In order that the quantity of cleaning liquid applied to the belt during the return stroke remains relatively highly limited, the time for the working stroke should be at least twice, preferably at least ten times, in particular at least one hundred times, longer than the time for the return stroke.

In connection therewith but also independently, the present invention provides that the quantity of cleaning liquid applied to the belt is controlled as a function of the traversing direction.

This permits the quantity of cleaning liquid applied to be controlled in particular in accordance with the length of time intervals between which the relevant area of the belt is cleaned. As a result, in this way an excess of cleaning liquid can be prevented in exactly the same way as overstressing the belt on account of the pressure with which the cleaning liquid is sprayed onto the belt.

In order to create substantially uniform cleaning time intervals, the quantity of cleaning liquid applied to the belt, at least as viewed over the entire traversing distance, should be greater in one traversing direction, the working stroke, than in the opposite traversing direction, the return stroke.

This also has the consequence that the main cleaning is carried out during the working stroke; the quantity of cleaning liquid applied to the belt during the working stroke should be two to ten times, preferably three to five times, greater than during the return stroke. In the extreme case, in particular in order to minimize the cleaning energy (for providing the cleaning liquid with a positive pressure), it can also be advantageous if, during the return stroke, no cleaning liquid is applied to the belt.

In order to influence the cleaning intensity of the relevant area of the belt to be cleaned, it is from time to time advantageous if the working stroke is executed with a discontinuous traversing speed.

In order to act on a specific area of the belt with cleaning liquid over a specific time duration, it is in this case relatively simple in control terms if, at least in one section, preferably over the entire traversing distance, the working stroke includes cleaning intervals for cleaning a specific area of the belt, during which the traversing unit is in a stable position, and traversing jumps, during which the cleaning device is moved to the next area of the belt to be cleaned.

In general, however, it is advantageous if the traversing speed and/or the quantity of cleaning liquid applied to the belt during the working stroke is controlled as a function of the level of contamination of the belt. On this basis, in the event of severe contamination, more cleaning liquid is applied at a lower traversing speed, which increases the cleaning intensity.

However, it can also be advantageous to control the traversing speed and/or the quantity of cleaning liquid applied to the belt during the working stroke as a function of the transverse profile of the level of contamination of the belt. This denotes that more highly contaminated areas of the belt are traveled over at a lower traversing speed and/or with longer stoppage times for cleaning and/or are acted on with more cleaning liquid.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic view of an embodiment of a cleaning device according to the present invention; and

FIGS. 2 and 3 are schematic views of various cleaning schemes according to the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

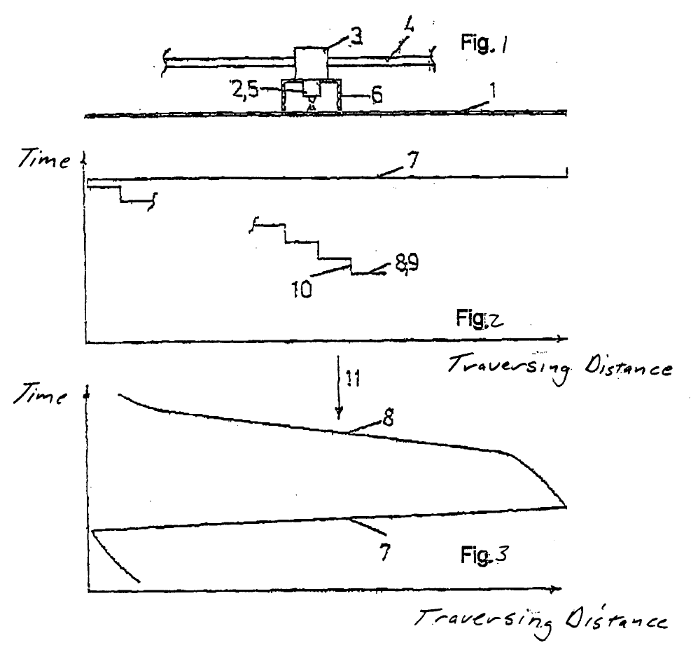

Referring now to the drawings, and more particularly to FIG. 1, there is shown a cleaning device 2 which substantially includes a cleaning nozzle 5, which sprays the cleaning liquid onto belt 1 to be cleaned at a pressure between 10 and 1000 bar. The cleaning liquid is predominantly composed of water and cleaning additives. The cleaning nozzle 5 is surrounded by a suction bell 6, which is intended to pick up water bouncing off belt 1 together with the contaminants detached.

In order to be able to clean a relatively large area of the belt, cleaning nozzle 5 is configured such that it can rotate and is preferably inclined with respect to the axis of rotation. Instead of one cleaning nozzle 5, a plurality of cleaning nozzles 5, configured differently if required, can also be used. Even spray pipes running transversely with respect to the belt running direction 11 are possible.

Cleaning device 5 is fixed to a traversing unit 3, which can be moved on a traversing beam 4 running transversely with respect to belt running direction 11.

In order to be able to influence the cleaning intensity, the cleaning intervals 8 within which a specific area of the belt is acted on with the cleaning liquid and the time intervals between the cleaning intervals, the control of the traversing speed and of the quantity of cleaning liquid sprayed onto belt 1 is carried out as a function of the traversing direction.

In this case, it has been recognized that dirt is deposited more intensively on already contaminated areas than on clean areas. For this reason, intensive cleaning with relatively long, preferably uniform, time intervals between is to be preferred over cleaning in which the areas are cleaned at shorter intervals but also with a lower intensity.

No regions of belt 1 are subjected to the pressure of the cleaning liquid for too long, in order to prevent damage to belt 1. However, this can also lead to specific regions of belt 1, as long as it is capable of absorbing water, having too much water after the cleaning and in this way influencing the transverse moisture profile of the fibrous web coming into contact with belt 1.

FIG. 2 shows a cleaning scheme in which belt 1 is cleaned in a specific traversing direction, working stroke 8, and in the opposite traversing direction, return stroke 7, is moved over the width of belt 1 at a relatively high traversing speed. The traversing speed during the return stroke, based on the width of belt 1, is approximately one hundred times higher than during working stroke 8.

Since return stroke 7 is carried out so quickly, the cleaning effect during return stroke 7 can be disregarded. Spraying with cleaning liquid can be carried out in a restricted manner during return stroke 7 or even stopped, which saves cleaning liquid and energy.

Over the entire traversing distance, that is to say the width of the belt 1, the cleaning in the working stroke 8 is carried out in cleaning intervals 10 for cleaning a specific area of the belt, during which traversing unit 3 is in a stable position. After a cleaning interval 10 has elapsed, there is then a traversing jump 9 in each case, during which cleaning device 2 is moved to the next area of the belt to be cleaned. In control terms, this is relatively simple and ensures that all the areas of the belt to be cleaned are cleaned substantially with equal intensity and within equal time intervals. However, the level of contamination can also be dealt with specifically via the duration of the cleaning intervals 10 and/or the quantity of cleaning liquid.

By using the cleaning scheme illustrated in FIG. 3, working stroke 8 is carried out without any traversing jumps 9 but with a changing traversing speed. Here, the traversing speed is reduced at the edges of belt 1, so that more intensive cleaning takes place there. In this case, more cleaning liquid can also assist the cleaning of the edges.

Return stroke 7 is carried out at a traversing speed which is approximately five times higher than during working stroke 8.

If the control is carried out as a function of the level of contamination of belt 1, then the latter is, if possible, also be measured and evaluated appropriately during the running of the machine. In this way, the machine control system can exert an influence on the traversing speed of traversing unit 3 and/or the quantity, the pressure and/or the temperature of the cleaning liquid led to cleaning nozzle 5.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for controlling a cleaning of an endlessly circulating belt in a machine for at least one of producing a fiber web and finishing the fiber web, comprising the steps of:
providing a cleaning device and a traversing unit coupled to said cleaning device;
applying a cleaning liquid to the belt with said cleaning device;
moving said cleaning device transversely with respect to the belt running direction with said traversing unit; and
controlling a traversing speed as a function of a traversing direction.

2. The method of claim 1, wherein the fiber web is one of a paper web, a board web and a tissue web.

3. The method of claim 1, further including the step of lowering said traversing speed, at least viewed over an entire traversing distance, in a traversing direction of a working stroke when compared to an opposite traversing direction of a return stroke.

4. The method of claim 3, further including the step of increasing a time for said working stroke to be a multiple of at least two times a time for said return stroke.

5. The method of claim 3, further including the step of increasing a time for said working stroke to be a multiple of at least ten times a time for said return stroke.

6. The method of claim 3, further including the step of increasing a time for said working stroke to be a multiple of at least one hundred times a time for said return stroke.

7. The method of claim 3, further including the step of carrying out said working stroke with a discontinuous said traversing speed.

8. The method of claim 7, further including the steps of providing a plurality of cleaning intervals in said working stroke in at least in a section of said entire traversing distance, said cleaning intervals for cleaning a specific area of the belt during which said traversing unit is in a stable position, and providing a plurality of traversing jumps during which said cleaning device is moved to a next area of the belt to be cleaned.

9. The method of claim 8, wherein said cleaning intervals are provided over said entire traversing distance.

10. The method of claim 3, further including the step of controlling at least one of said traversing speed and a quantity of cleaning liquid applied to the belt during said working stroke as a function of a level of contamination of the belt.

11. The method of claim 3, further including the step of controlling at least one of said traversing speed and a quantity of cleaning liquid applied to the belt during said working stroke as a function of a transverse profile of a level of contamination of the belt.

12. A method for controlling a cleaning of an endlessly circulating belt in a machine for at least one of producing a fiber web and finishing the fiber web, comprising the steps of:
providing a cleaning device and a traversing unit coupled to said cleaning device;
applying a cleaning liquid to the belt with said cleaning device;
moving said cleaning device transversely with respect to the belt running direction with said traversing unit; and
controlling a quantity of said cleaning liquid applied to the belt as a function of a traversing direction.

13. The method of claim 12, wherein the fiber web is one of a paper web, a board web and a tissue web.

14. The method of claim 12, further including the step of increasing said quantity of a cleaning liquid, at least viewed over an entire traversing distance, in a traversing direction of a working stroke when compared to an opposite traversing direction of a return stroke.

15. The method of claim 14, wherein said quantity of said cleaning liquid during said working stroke is increased by a multiple approximately between two times and ten times greater than during said return stroke.

16. The method of claim 14, wherein said quantity of said cleaning liquid during said working stroke is increased by a multiple approximately between three times and five times greater than during said return stroke.

17. The method of claim 4, wherein no said cleaning liquid is applied to the belt during said return stroke.

18. The method of claim 14, further including the step of carrying out said working stroke with a discontinuous said traversing speed.

19. The method of claim 18, further including the steps of providing a plurality of cleaning intervals in said working stroke in at least in a section of said entire traversing distance, said cleaning intervals for cleaning a specific area of the belt during which said traversing unit is in a stable position, and providing a plurality of traversing jumps during which said cleaning device is moved to a next area of the belt to be cleaned.

20. The method of claim 19, wherein said cleaning intervals are provided over said entire traversing distance.

21. The method of claim 14, further including the step of controlling at least one of a traversing speed and said quantity of cleaning liquid applied to the belt during said working stroke as a function of a level of contamination of the belt.

22. The method of claim 14, further including the step of controlling at least one of a traversing speed and said quantity of cleaning liquid applied to the belt during said working stroke as a function of a transverse profile of a level of contamination of the belt.
